(19) United States
(12) Patent Application Publication
(10) Pub. No.: US 2006/0086594 A1
(43) Pub. Date: Apr. 27, 2006

(54) Energy control device

(75) Inventors: Gunther Reimold, Oberderdingen (DE); Siegfried Mannuss, Sternenfels (DE); Willi Reichert, Kurnbach (DE)

Correspondence Address: AKERMAN SENTERFITT, P.O. BOX 3188, WEST PALM BEACH, FL, 33402-3188, US

(73) Assignee: E.G.O. Elektro-Geratebau GmbH, Oberderdingen (DE)

(21) Appl. No.: 11/247,019

(22) Filed: Oct. 11, 2005

Related U.S. Application Data
(63) Continuation of application No. PCT/EP04/03707, filed on Apr. 7, 2004.

(30) Foreign Application Priority Data
Apr. 11, 2003 (DE) 103 17 277 7

(51) Int. Cl. H01H 9/28

(52) U.S. Cl. 200/43.17

(57) ABSTRACT

An energy control device comprises a switching device and a control system. The switching device is provided with a switch contact adjacent to a counter-contact on one side and to a counter-stopper on the other side thereof. The counter-stopper is arranged on an springy arm which is made of a round steel spring-wire and has on one end thereof a spiral spring segment. The spiral spring segment makes it possible to mount the springy arm on an elongated supporting rod in such a way that it is displaceable in a longitudinal direction, thereby displaying a certain clearance. The springy arm is applied with the other end thereof to an eccentric disc, thereby making it possible to modify the position and consequently place of the counter-stopper.

### CROSS-REFERENCE TO RELATED APPLICATIONS

This application is a continuation of PCT patent application No. PCT/EP2004/003707, filed Apr. 7, 2004, the entire contents of which are incorporated herein by reference. This application also claims the benefit of DE 103 17 277.7, filed Apr. 11, 2003.

### BACKGROUND OF THE INVENTION

The invention relates to an energy control device.

Such an energy control device is described in EP 898 291 A2 where, in addition to a resiliently mounted appliance switch with switching contact, there is a further spring with an opposite contact. The end of said spring engages on a cam disk, so that it is possible to modify its position relative to a switching contact of the appliance switch for influencing the switching behaviour. The spring is firmly connected to the base of the energy control device and is only movable within the scope of its elasticity.

### SUMMARY OF THE INVENTION

The problem of the invention is to provide an energy control device as defined hereinbefore, in which an influencing of the switching behaviour of an appliance switch contained therein can be improved, particularly with respect to a mechanism with a resilient arm forming a counterstop for a switching contact of the appliance switch.

This problem may be solved by an energy control with an adjusting device for an appliance switch contained in the energy control device, wherein a position change of the appliance switch leads to a change to an adjustable energy level, the appliance switch carrying a switching contact, wherein the switching contact in an ON position engages on an opposite contact and in an OFF position engages with a variable contact spacing with respect to the opposite contact on a counterstop of a counterstop mechanism. Additionally, the adjusting device has an energy adjusting device for the energy level and a contact spacing adjusting device separate from the energy adjusting device, together with operating means for the operation of the contact spacing adjusting device. The contact spacing adjusting device has a spacing cam disk with a varying radius, wherein the counterstop mechanism engages on an external radius of the spacing cam disk, the counterstop mechanism carrying or at least partly forming the counterstop with a resilient arm in elastically pressed manner as a result of biasing. A bearing is provided at the counterstop mechanism with a design provided clearance of the bearing at least in a direction perpendicular to a direction in which the adjustment of the contact spacing takes place as a movement.

The term energy control device is here understood to mean any switching device. Advantageous and preferred developments of the invention form the subject matter of the claims and are defined in greater detail hereinafter. The wording of the claims is by express reference made into part of the content of the description.

According to the invention, in an energy control device as defined hereinbefore, a counterstop mechanism is fitted or mounted on the energy control device in such a way that there is a certain clearance with a certain freedom of movement or mounting as a result of its very design. This clearance can admittedly be provided in several different directions. According to the invention it is provided in at least one direction, which is perpendicular to the direction in which the adjustment of the contact spacing takes place as a movement or in which is located the movement path of the switching contact and also the opposite contact.

The advantage of such a design provided clearance compared with a rigid arrangement known from the prior art is in particular that it is thus possible to compensate certain tolerances or manufacturing imprecisions by self-adjustment or movement, within the scope of the bearing clearance. Thus, e.g. it is also possible to compensate thermal expansion and the like.

It is possible that the resilient arm is elastically movable in precisely the clearance direction in addition to the design provided bearing clearance. In this case the clearance does not replace the mobility of the arm and instead assists it or makes possible a certain mobility of the arm independently of an initiation of the movement, e.g. by the contact spacing adjusting device or the counterstop mechanism.

One possibility for the construction of a bearing or mounting is to provide the counterstop mechanism with a tubular or sleeve-like section and to place the same on a bearing in the form of an elongated bearing rod. If the bearing rod is directed towards the design provided bearing clearance, a certain displaceability can be provided here. This displaceability then corresponds to the design provided clearance. In addition, the counterstop mechanism can be rotatable on or about such a bearing rod.

A bearing for the counterstop mechanism can be connected to a supporting device, which supports the appliance switch. This supporting device can be fixed to the energy control device or a base thereof, e.g. as a separate subassembly. The supporting device can be adjustable by means of an energy adjusting device, which can also be e.g. a cam disk with a varying radius. The advantage of an arrangement of the bearing and therefore the counterstop mechanism or a contact spacing adjusting device on a supporting device for the appliance switch is in particular that the appliance switch and counterstop mechanism are consequently directly interconnected, so that fewer problems arise.

It is also possible for the aforementioned supporting device to have an e.g. hook-like holder. The counterstop mechanism or resilient arm can be held in such a holder in a transporting position. This transporting position more particularly means that here the resilient arm is raised from the spacing cam disk and consequently e.g. an easier installation can take place. This also makes it possible to create a more compact subassembly which is introduced into an energy control device. During the initial use of the energy control device, which is also understood to mean an adjustment following manufacture, the counterstop mechanism or the resilient arm can be removed from the holder in a substantially or completely automatic manner. This means that the resilient arm slides or is raised from the holder, e.g. by a device which is also used for other movements of the counterstop mechanism.

In an embodiment of the invention the counterstop mechanism can be constructed in one piece or part. Advantageously it is integrally constructed with the resilient arm and/or a tubular section provided for the bearing, e.g. for engagement on an elongated bearing rod. An integral construction can in part be more easily manufactured and in particular the operating reliability is increased. Fewer parts are present which can be moved relative to one another.

One possibility for the construction of a counterstop mechanism is a corresponding bending of a spring wire, which can e.g. be a round wire. A tubular section can be constructed in that part of the spring wire is wound in spiral spring-like manner. Apart from the bearing or mounting function, said spiral spring-like construction can provide elasticity of movement of the resilient arm or counterstop mechanism with the counterstop.

Besides the construction of part of the bearing, a counterstop can also be produced by a bend, particularly on the resilient arm. This bend or counterstop respectively can project substantially perpendicularly from the longitudinal path of the counterstop mechanism or resilient arm. According to one possibility, particularly in the case of the aforementioned construction of the counterstop mechanism with a bent spring wire, the bend can be roughly U-shaped. The two U-legs can be positioned close to or engage with one another. This permits a more rigid construction. Moreover the space requirement for a counterstop is reduced.

Notwithstanding the bearing clearance, the counterstop mechanism can be laterally guided on the spacing cam disk with which it engages and this advantageously takes place at at least one free section or end. This in particular prevents excessive movement of the counterstop relative to the switching contact. Such a lateral guidance can be provided by lateral sections or side walls. These can be provided on either side of the spacing cam disk and project radially over the same. This creates a type of depressed path or groove for the counterstop mechanism on the spacing cam disk.

In its longitudinal path the resilient arm can be bent into or out of the plane of the energy controller or switching device. This makes it possible to vary an engagement on the spacing cam disk spatially or in the longitudinal direction of the rotation axis for the spacing cam disk. This leads to a greater design freedom for the rotation axis and also the resilient arm, particularly with regards to the space utilization.

Advantageously the counterstop can be positioned closer to the bearing of the counterstop mechanism than to the engagement of the counterstop mechanism on the spacing cam disk. This can be advantageous in that in this way the force exerted by the engagement or striking of the switching contact against the counterstop is absorbed directly or with a limited moment arm by the bearing of the counterstop mechanism. A possible excessive sagging of the counterstop mechanism or the resilient arm would lead to undesired tolerances and to a possible faulty switching behaviour.

It is advantageous here to allow the switching contact to engage with or strike against the counterstop in the direction in which the counterstop mechanism engages on the spacing cam disk. Thus, said force is absorbed both by the bearing and by the engagement on the spacing cam disk.

The supporting device for the appliance switch can be mechanically linked with a connecting device. The connecting device, e.g. together with an opposite contact for the switching contact, can be linked with a base of the energy control device by injection moulding. The supporting device can be guided or linked with the connecting device by means of a guide, which permits a precise arrangement. A connection or fixing can be carried out following an adjusting process for the precise position. The guide can be used for increased precision.

These and further features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

An embodiment of the invention is described hereinafter relative to the attached drawings, wherein show:

FIG. 1A representation of an appliance switch for an inventive energy control device with counterstop mechanism and Heating means for the appliance switch.

FIG. 2 The appliance switch of FIG. 1 with engagement on a cam disk, as well as a spacing cam disk for the resilient arm Of the contact spacing adjusting device.

FIG. 3 A plan view of an energy control device with the installed components of FIGS. 1 and 2.

### DETAILED DESCRIPTION OF THE EMBODIMENT

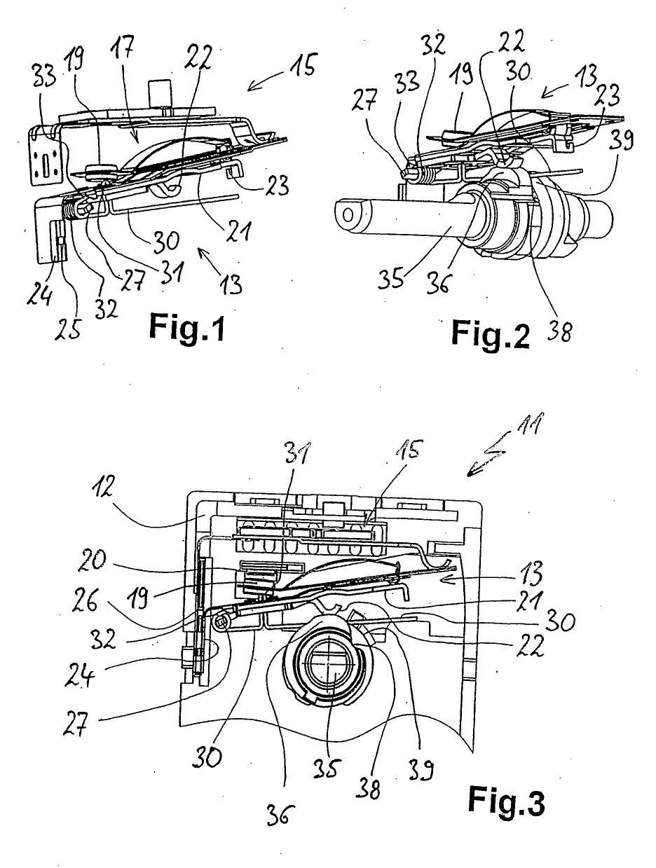

FIGS. 1 to 3 show an energy control device 11 overall in plan view with individual components thereof in perspective views.

FIG. 1 shows, extracted from the energy control device 11 of FIG. 3, an appliance switch 13 with which is associated in known manner a heating means 15. This fundamental arrangement and the function of the heating means and appliance switch can e.g. be gathered from EP 977 231 A2 and the already cited EP 898 291 A2, to which express reference is made here.

The appliance switch 13 has a catch spring 17 carrying at one end a switching contact 19 with which is associated an opposite contact 20 on the appliance base 12. A switching process is initiated through the engagement of the switching contact 19 with the opposite contact 20.

The catch spring 17 is fixed to a support 21 having a downwardly projecting, bent slider 22. A hang-in 23 is provided at the right-hand end of support 21 and further reference will be made thereto hereinafter.

The support 21 is in turn fixed to a holder 24, which has cutouts 25. The holder 24 can be fixed to a base holder 26 injection moulded into an appliance base 12, e.g. by bonding, riveting or spot welding. On the base holder 26 can be provided projections or the like corresponding to the holder cutouts 25 and by means of which fixing is possible within predetermined dimensions, particularly in grid dimensions. There is also a displacement with a certain guidance action of the base holder 26 for holder 24. This guidance action can be used in order to determine the precise position of the holder 24 on the base holder 26 or on the appliance base 12, which can be used for adjusting the energy control device 11.

In addition, from the support 21 projects, more particularly in integral manner, a bearing rod 27, to which further detailed reference will be made hereinafter.

A resilient arm 30 of round spring wire is located on the support 21. In the left-hand area the resilient arm 30 has a U-shaped bend as a counterstop 31, which projects through the support 21 and on which engages when the contacts are opened, the switching contact 19. In the far left region, the resilient arm 30 forms a spiral spring section 32, which has a roughly tubular construction. With said spiral spring section 32 the resilient arm 30 is mounted on the bearing rod 27. By means of a hang-on 33 constructed as a short portion and which projects from the spiral spring section 32, the resilient arm 30 is mounted with respect to the support 21.

The fit of the resilient arm 30 or spiral spring section 32 forming the aforementioned counterstop mechanism on the bearing rod 27 is inventively such that a displacement in the longitudinal direction of the bearing rod 27 is possible. As a result at the start of hooking or the like in certain circumstances the resilient arm 30 can be released again, thereby ensuring functionality.

It is also possible to make the internal diameter of the spiral spring section 32 much larger than the external diameter of the bearing rod 27. This leads to a further radial clearance of the bearing, in addition to the longitudinal clearance. To a certain extent this also improves the rotatability or mobility of the resilient arm 30 on bearing rod 27.

The right-hand end of the resilient arm 30 can be hung on the hang-in 23 at the right-hand end of the support 21. As a result the arm 30 is substantially fixed and is so closely applied to the support 21 that handling is greatly simplified. It is scarcely possible for the arm 30 to hang at a random location.

For operating the energy control device 11 or appliance switch 13 an operating spindle 35 is provided. The latter has a first, noncircular disk 36, particularly in the form of a cam disk. The slider 22 of the support 21 supporting the appliance switch 13 engages on the first disk 36. It ensures in per se known manner an adjustment of the position of the appliance switch 13 or switching contact 19 relative to the opposite contact 20. In the case of an energy control device this in particular allows certain energy settings to be carried out, i.e. so-called cooking stages on a hob.

Besides the first disk 36 a second disk 38 is provided. The second disk is also advantageously noncircular and its shape can differ significantly from that of the first disk 36. Against said second disk 38 engages the resilient arm 30 with a part to the right of the counterstop 31. Through the resilient engagement of arm 30 on the second disk 38, which is in particular brought about by the spring action of the spiral spring section 32, the arm constantly engages on the second disk 38. This means that due to a rotation about a rotation axis passing through the bearing rod 27 the upwardly projecting counterstop 31 performs a predefinable movement.

For the better guidance of the resilient arm 30 on the second disk 38, particularly for maintaining a lateral guidance, said second disk 38 is countersunk between juxtaposed disks or sections. For this purpose to the right of the second disk 38 is provided a right-hand side wall 39, e.g. in the form of a further disk. The left-hand side wall for the second disk 38 is formed by the first disk 36. In such a channel or depression the resilient arm 30 passes with a certain lateral clearance, namely beyond the width of the second disk 38, but arm 30 cannot move beyond said width.

This reveals one of the main advantages of the hang-in 23. On installing the energy control device with hung-in, resilient arm 30 there is a significant simplification to the insertion of the operating spindle 35 with disks 36, 38 and 39. The resilient arm 30 can be released from the hang-in 23 and engages on the second disk 38 as a result of its spring action. This release can also be brought about by one of the disks 36, 38. Thus, the resilient arm 30 can be released from the hang-in 23. As a result of a lateral biasing the resilient arm 30 can snap away from the hang-in 23 and engage against the second disk 38.

1. An energy control device with an adjusting device for an appliance switch contained in said energy control device, wherein a position change of said appliance switch leads to a change to an adjustable energy level, said appliance switch carrying a switching contact, wherein said switching contact in an ON position engages on an opposite contact and in an OFF position engages with a variable contact spacing with respect to said opposite contact on a counterstop of a counterstop mechanism,
said adjusting device having an energy adjusting device for said energy level and a contact spacing adjusting device separate from said energy adjusting device, together with operating means for the operation of said contact spacing adjusting device,
said contact spacing adjusting device having a spacing cam disk with a varying radius,
wherein said counterstop mechanism engages on an external radius of said spacing cam disk, said counterstop mechanism carrying or at least partly forming said counterstop with a resilient arm in elastically pressed manner as a result of biasing, and
wherein a bearing is provided at said counterstop mechanism with a design provided clearance of said bearing at least in a direction perpendicular to a direction in which said adjustment of said contact spacing takes place as a movement.

2. The energy control device according to claim 1, wherein said resilient arm is elastically movable in a direction of said clearance of said bearing.

3. The energy control device according to claim 1, wherein said counterstop mechanism is mounted with a tubular section on a bearing rod as a bearing, said bearing rod being directed towards said bearing clearance.

4. The energy control device according to claim 3, wherein said counterstop mechanism is rotatably mounted on said bearing rod.

5. The energy control device according to claim 1, wherein a bearing or bearing rod is connected to a supporting device supporting said appliance switch and fixed as a separate subassembly to said energy control device,

6. The energy control device according to claim 5, wherein said supporting device is adjustable by said energy adjusting device.

7. The energy control device according to claim 5, wherein said supporting device has a holder for temporarily fixing said resilient arm in a position in which said resilient arm is raised in said adjusting direction from aid spacing cam disk.

8. The energy control device according to claim 7, wherein said holder has a hook-like construction.

9. The energy control device according to claim 1, wherein said counterstop mechanism is constructed in one piece with said resilient arm for said bearing rod.

10. The energy control device according to claim 1, wherein said counterstop mechanism is constructed in one piece with said tubular section for said bearing rod.

11. The energy control device according to claim 9, wherein said counterstop mechanism is a bent spring wire, and in particular a tubular section is formed for mounting on a bearing rod as a bearing through a spiral spring-like construction of part of the spring wire.

12. The energy control device according to claim 10, wherein said counterstop mechanism is a bent spring wire, and in particular a tubular section is formed for mounting on a bearing rod as a bearing through a spiral spring-like construction of part of the spring wire.

13. The energy control device according to claim 1 1, wherein said counterstop mechanism has a tubular section being formed for mounting on a bearing rod as a bearing through a spiral spring-like construction of a part of said spring wire.

14. The energy control device according to claim 1, wherein said counterstop is formed by a bend of said resilient arm.

15. The energy control device according to claim 14, wherein said counterstop projects substantially at right angles from a longitudinal path of said counterstop mechanism or said resilient arm.

16. The energy control device according to claim 14, wherein said bend is roughly U-shaped with two U-legs.

17. Energy control device according to claim 1, wherein said counterstop mechanism is laterally guided on said spacing cam disk.

18. The energy control device according to claim 17, wherein said counterstop mechanism is laterally guided on said spacing cam disk by lateral portions or side walls, which project over both sides of said spacing cam disk.

19. The energy control device according to claim 1, wherein said counterstop is closer to a bearing of said counterstop mechanism than said engagement of said counterstop mechanism on said spacing cam disk.

20. The energy control device according to claim 1, wherein said switching contact engages on said counterstop in a direction in which said counterstop mechanism engages on said spacing cam disk.
